(19) United States
(12) Patent Application Publication
(10) Pub. No.: US 2012/0075744 A1
(43) Pub. Date: Mar. 29, 2012

(54) METHOD OF OPTIMIZING FLYING HEIGHT OF HEAD AND HARD DISK DRIVE MANUFACTURED BY THE SAME

(75) Inventors: Seong Yong YOON, Seongnam-si (KR); Myung Wook Song, Suwon-si (KR); Chang-Hwan Lee, Seoul (KR); Su-Hyeon Kim, Bucheon-si (KR)

(73) Assignee: Samsung Electronics Co., Ltd, Suwon-si (KR)

(21) Appl. No.: 13/233,845

(22) Filed: Sep. 15, 2011

(30) Foreign Application Priority Data
Sep. 27, 2010 (KR) 10-2010-0092997

(51) Int. Cl. G11B 21/12

(52) U.S. Cl. 360/75; G9B/21.021

(57) ABSTRACT

A hard disk drive includes a controller that optimizes a flying height of a head of a hard disk drive. The controller determines an optimal flying height of a head based on a preset table value and an MRR value of a head measured during a hard disk drive manufacturing process and sets the head according the determined optimal flying height such that recording capacitance is improved.

### CROSS-REFERENCE TO RELATED APPLICATIONS

This application claims priority under 35 U.S.C. §119(a) from Korean Patent Application No. 10-2010-0092997, filed on Sep. 27, 2010, in the Korean Intellectual Property Office, the disclosure of which is incorporated herein in its entirety by reference.

### BACKGROUND

1. Field of the General Inventive Concept

The inventive concept relates to a method of optimizing a flying height (FH) of a head of a hard disk drive (HDD), and an HDD manufactured by the method, and more particularly, to a method of optimizing an FH of a head of an HDD, by which an FH of a head may be optimized based on a preset table value and a magnetic resistor resistance (MRR) value of a head measured during an HDD manufacturing process so that recording capacitance may be improved compared to a related technology, and an HDD manufactured by the method.

2. Description of the Related Art

In general, HDDs are data storage devices that are capable of converting digital electronic pulses including data information into permanent magnetic fields and recording the permanent magnetic fields on a disk, or reproducing data recorded on the disk. The HDD having merits of recording and reproducing a large amount of data at high speed is used as a typical auxiliary memory device of a computer system.

Data is recorded in at least one track on a disk. The disk is rotatably coupled to a spindle motor and data is read and written by a read/write unit mounted on an actuator arm that is rotated by a voice coil motor. A so-called head is generally used as the read/write unit. The head reads and writes data by detecting a change in magnetism generated from a surface of the disk.

A flying height (FH) of a head refers to an interval between a surface of head and a surface of a disk. The FH affects general drive performance such as recording capacitance or recording density of a disk and reliability of a drive. When the FH of a head decreases, recording performance becomes better but an adjacent track erase (ATE) phenomenon that data on an adjacent track of a disk is erased due to a write current amount provided to the head is generated. In contrast, when the FH of a head increases, the ATE phenomenon is reduced but the recording performance of an HDD is deteriorated.

Thus, a process of adjusting an FH of a head is very important during manufacturing of an HDD. In a typical conventional HDD manufacturing process, the FH of a head is generally maintained by default. In other words, the FH of a head is maintained constant during the manufacturing of the HDD regardless of the type and characteristics of the head. As a result, recording performance, particularly, recording capacitance, of an HDD is deteriorated.

### SUMMARY OF THE GENERAL INVENTIVE CONCEPT

The present general inventive concept provides a method of optimizing a flying height (FH) of a head of a hard disk drive (HDD), by which an FH of a head may be optimized based on a preset table value and a magnetic resistor resistance (MRR) value of a head measured during the HDD manufacturing process so that recording capacitance may be improved compared to a related technology, and an HDD manufactured by the method.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a method of optimizing a flying height of a head of a hard disk drive which includes measuring a parameter value with respect to the flying height of the head and a recording capacitance value of the hard disk drive corresponding to the parameter value and generating a predetermined table based on measured values, and optimizing the flying height of the head by comparing a measured parameter value in a hard disk drive manufacturing process with the table.

The optimizing of the flying height of the head may include measuring the parameter value in any one process selected from the hard disk drive manufacturing process, and comparing the parameter value measured in the measuring of the parameter value with corresponding value of the table.

The optimizing of the flying height of the head may further include selecting an optimal recording capacitance value of the corresponding values of the table corresponding to the parameter value, and optimizing the flying height of the head by resetting the flying height of the head based on the optimal recording capacitance value.

The optimal recording capacitance value may be a maximum value of recording capacitance values of the table.

The parameter value may be selected from an MRR (magnetic resistor resistance) value of the head, an EWAC (write width including an erase band width by an AC field) value of the head, an MRR value of the hard disk drive, and an EWAC value of the hard disk drive, and the hard disk manufacturing process may comprise a head stack assembly assembling process, a servo write process, a function test process, a burn-in process, and a final test process.

The MRR value of the head may be measured in at least any one process selected from the entire processes of the hard disk drive manufacturing process.

The EWAC value of the head may be measured in the burn-in process.

The measuring of a parameter value with respect to the flying height of the head and a recording capacitance value of the hard disk drive corresponding to the parameter value and the generating of a predetermined table based on measured values may include defining a type of the head, selecting a flying height of the head, measuring at least one parameter value based on the flying height of the head, and measuring recording capacitance of the hard disk drive according to a measured parameter value.

The table generated in the measuring of a parameter value with respect to the flying height of the head and a recording capacitance value of the hard disk drive corresponding to the parameter value and the generating of a predetermined table based on measured values may be stored in a memory or on a disk.

According to another feature of the inventive concept, there is provided a hard disk drive which includes a head to read/write information with respect to a disk, and a controller to optimize a flying height of a head by comparing parameter values measured in a hard disk drive manufacturing process with a pre-generated table, wherein the table is generated based on measured values of a parameter value with respect to the flying height of the head and a recording capacitance value of the hard disk drive corresponding to the parameter value.

The controller may measure the parameter value in any one process selected from the hard disk drive manufacturing process, compare a measured parameter value with values of the table, select an optimal recording capacitance value of the corresponding values of the table corresponding to the parameter value, and control optimization of the flying height of the head by resetting the flying height of the head based on the optimal recording capacitance value.

The optimal capacitance value may be a maximum value of the recording capacitance values of the table.

The parameter value may be selected from an MRR (magnetic resistor resistance) value of the head, an EWAC (write width including an erase band width by an AC field) value of the head, an MRR value of the hard disk drive, and an EWAC value of the hard disk drive, and the hard disk manufacturing process may include a head stack assembly assembling process, a servo write process, a function test process, a burn-in process, and a final test process.

The MRR value of the head may be measured in at least any one process selected from the entire processes of the hard disk drive manufacturing process, and the EWAC value of the head is measured in the burn-in process.

In another feature of the present general inventive concept, a hard disk drive module having at least one disk to store data includes a head disposed above the at least one disk and adjustable according to a flying height, a memory unit to store a plurality of parameters measured during a pre-determined manufacturing process of the hard disk drive module, and a controller in electrical communication with the memory unit to output a plurality of control signals in response to each measured parameter among the plurality of measured parameters such that each control signal sets the head at a corresponding flying height, wherein a recording capacitance of the hard disk drive module is measured at each flying height set by the corresponding control signal generated by the controller.

In still another feature, a method of optimizing a flying height of a head in a hard disk drive module having at least one disk to store data includes storing a plurality of parameters measured during a pre-determined manufacturing process of the hard disk drive module, setting the head at a plurality of flying heights, each flying height corresponding to a measured parameter among the plurality of measured parameters, and measuring a recording capacitance of the hard disk drive module at each set flying height.

In yet another feature of the present general inventive concept, a method of optimizing a flying height of a head of a hard disk drive includes determining a manufacturing process of the hard disk drive during which to optimize the flying height of the head, measuring during the determined manufacturing process a parameter of the head to be cross-referenced with a pre-determined parameter listed in a pre-generated table stored in a memory unit, matching the measured parameter with the pre-determined parameter to determine a corresponding recording capacitance of the head, and adjusting the flying height of the head according to the determined recording capacitance.

### BRIEF DESCRIPTION OF THE DRAWINGS

The above and/or other features and utilities of the present general inventive concept will become apparent and more readily appreciated from the following description of the exemplary embodiments, taken in conjunction with the accompanying drawings of which:

FIG. 1 is an exploded perspective view of an HDD manufactured by a method of optimizing an FH of a head according to an exemplary embodiment of the present general inventive concept;

FIG. 2 is a control block diagram of the HDD of FIG. 1;

FIG. 3 is a graph showing a relationship between an EWAC value and the FH of a head;

FIG. 4 is a graph showing a relationship between an EWAC value and recording capacitance of recording performance of an HDD;

FIG. 5 is a graph showing a relationship between an MRR value of a head and an MRR value of an HDD;

FIG. 6 is a flowchart illustrating a method of optimizing an FH of a head according to an exemplary embodiment of the present general inventive concept;

FIG. 7 is a flowchart illustrating a table producing operation;

FIG. 8 shows an example of table values preset according to an order of FIG. 7; and

FIG. 9 is a flowchart illustrating a method of optimizing an FH of a head during an HDD manufacturing process.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to describe present general inventive concept while referring to the figures.

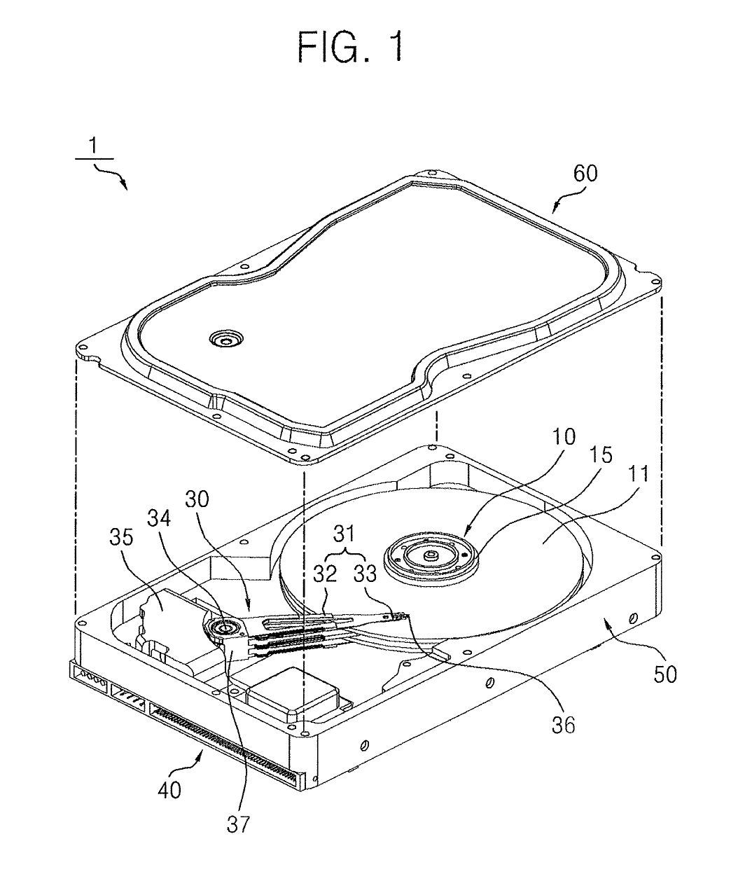

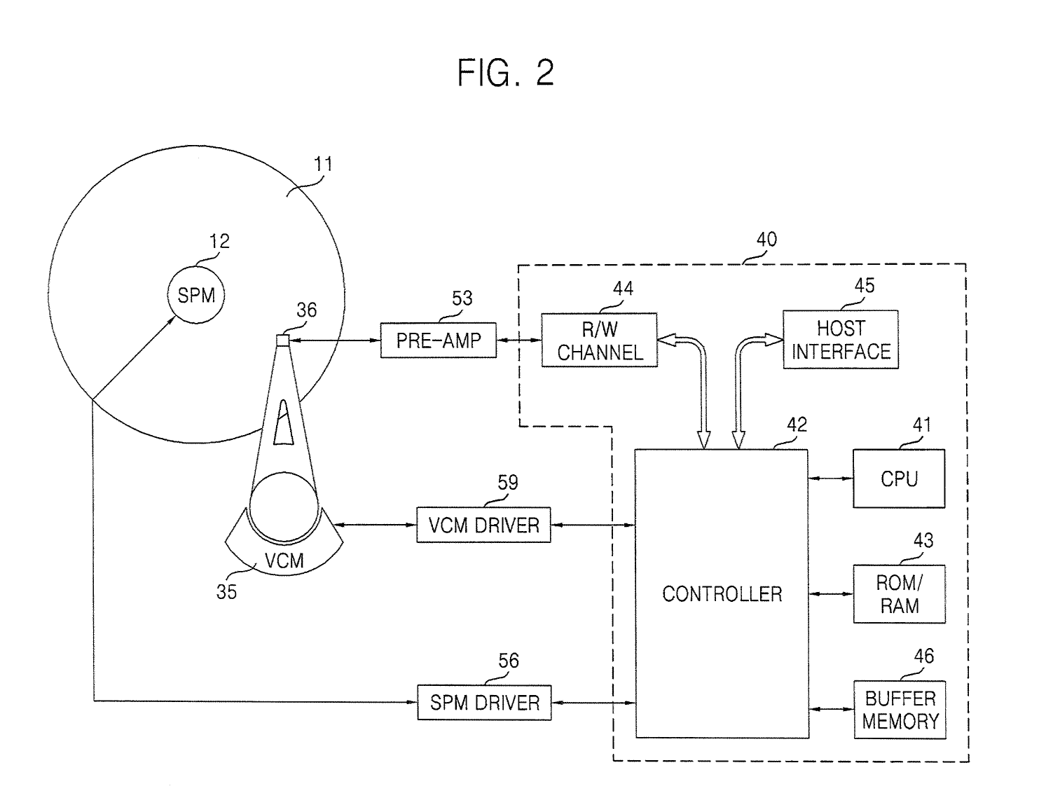

FIG. 1 is an exploded perspective view of a hard disk drive apparatus (HDD) 1. The HDD 1 may be manufactured based on a method of optimizing an FH of a head according to an exemplary embodiment of the present general inventive concept. FIG. 2 is a control block diagram of the HDD of FIG. 1.

Referring to FIGS. 1 and 2, the HDD 1 includes a disk stack assembly 10 having a plurality of disks 11 to record and store data, a head stack assembly (HSA) 30 on which a head 36 to read out data on the disks 11 while rotating across the disks 11 around a pivot shaft 34 as a shaft center is installed, a circuit block 40 having most circuit parts installed on a printed circuit board (PCB) and to control various parts, a base 50 on which the above constituent elements are assembled, and a cover 60 to cover the base 50.

When a recording or reproducing operation starts in the above-described structure, the head 36 is moved to a predetermined position on the disks 11 that is rotating and thus the recording or reproducing operation is performed.

The HSA 30 includes an actuator arm 31 moving the head 36 to access the data on the disks 11, a pivot shaft holder 37 rotatably supporting the pivot shaft 34 and to which the actuator arm 31 is coupled and supported thereby, and a bobbin (not shown) extending from the pivot shaft holder 37 in the opposite direction to the actuator arm 31 and wound by a voice coil motor (VCM) coil to be located between magnets of a VCM 35.

The actuator arm 31 may include a swing arm 32 rotating around the pivot shaft 34 by the VCM 35 and a suspension 33 supported by the swing arm 32 and having a leading end to which the head 36 is coupled.

The VCM 35 is a sort of a drive motor to pivot the actuator arm 31 to move the head 36 to a desired position on the disks 11, according to the Fleming's left hand rule, that is, a principle that a force is generated when current flows in a conductive body existing in a magnetic field. As current is applied to the VCM coil located between the magnets, a force is applied to the bobbin to pivot the bobbin.

Accordingly, as the actuator arm 31 extending from the pivot shaft holder 37 in the direction opposite to the bobbin pivots, the head 36 supported at an end portion of the actuator arm 31 searches and accesses a track moving across the disks 11 that is rotating so that accessed information is signal processed.

The head 36 reads or writes information with respect to the disks 11 that is rotating by sensing a magnetic field formed on a surface of one of the disks 11 or magnetizing the surface of one of the disks 11. The head 36 includes a read head to reproduce data from a track(s) and a write head to record data on a track(s).

The disk stack assembly 10 to rotate the disks 11 includes the disks 11 to record and store data, a spindle motor (SPM) 12 (see FIG. 2) to rotate the disks 11, and a clamp 15 (see FIG. 1) to fix the disks 11 on the SPM 12 by elastically pressing the disks 11.

The disks 11 may store data and be rotated by the SPM 12. The SPM 12 is driven by an SPM driver 56 (see FIG. 2).

A pre-amplifier (pre-AMP) 53 amplifies a data signal reproduced by the head 36 from the disks 11 and an amplifier read signal is output to a read/write channel 44. When data is written to the disks 11, the pre-AMP 53 amplifies a write current converted by the read/write channel 44 so as to be written to the disks 11 by the head 36.

The circuit block 40 will be briefly described with reference to FIG. 2. The read/write channel 44 converts a signal amplified by the pre-AMP 53 to a digital signal and transmits a converted digital signal to the controller 42. The controller 42 may further process the converted digital signal from the read/write channel 44 and may deliver the converted digital signal to a host device (not shown) via a host interface 45. Conversely, user input data may be received via the host interface 45. The received user input data may be converted to a binary data stream using the controller 42 that is easy to write, and the converted binary data stream is output to the pre-AMP 53.

The host interface 45 transmits the data converted to a digital signal to the host device, or receives user input data from the host device and input to the read/write channel 44 via a controller 42.

The controller 42 receives read data R/DATA decoded by the read/write channel 44 and transmits received data to a host under control of a central processing unit (CPU) 41 during a read operation, and outputs write data W/DATA output from the host to the read/write channel 44 to be written to any one of the disks 11 under control of the CPU 41 during a write operation.

The CPU 41 controls an operation of the controller 42 based on a control signal/control code stored in a memory unit 43. The memory unit 43 may include read only memory (ROM) and/or a random access memory (RAM). Although in FIG. 2, the ROM and the RAM are illustrated as a single memory unit 43 for convenience of explanation, they may be regarded as separated memory units.

The VCM driver 59 generates a drive current to drive the VCM 35 by receiving a control signal of the controller 42 and outputs a generated drive current to a voice coil (not shown) of the VCM 35. Thus, the VCM 35 moves the head 36 to a track of the disks 11 to read according to the direction and level of the drive current output from the VCM driver 59.

The SPM driver 56 controls an amount of current applied to the spindle motor 12 by receiving a control signal of the controller 42.

A buffer memory 46 may temporarily store data to be communicated between the HDD 1 and a host connected to the host interface 45. In at least one exemplary embodiment, the buffer memory 46 is assumed to be present in the circuit block 40. However, the buffer memory 46 may be provided outside the circuit block 40.

Various parameters may be related to optimization of recording performance of the HDD 1. For example, write current (WC) of the head 36, over shoot amplitude (OSA), or over shoot duration (OSD) are examples of parameters that may affect optimization of the HDD 1 recording performance.

The flying height (FH) of the head 36 is an interval between the head 36 and the disks 11. The FH may influence the recording performance, particularly recording capacitance or recording density, of the HDD 1. That is, as described above, when the FH of the head 36 is low, an adjacent track erase (ATE) phenomenon is generated so that the recording performance is deteriorated. However, when the FH of the head 36 is high, the ATE phenomenon is reduced whereas the recording performance of the HDD 1 is lowered instead.

Thus, to solve the problem of a related technology in which a process is performed while maintaining the FH of a head to be default, a method of optimizing the FH of a head is needed which may be achieved by the method of optimizing an FH of a head according to the present general inventive concept.

The method of optimizing a FH of the head 36 may involve four parameters of a HDD 1 and the head 36. The four parameters include a magnetic resistor resistance (MRR) value of the head 36, an MRR value of a head measured in a level of the HDD 1 having the head 36 (hereinafter, referred to as the drive MRR value), a write width including an erase band width by AC field (EWAC) value of the head 36, and an EWAC value of a head measured in a level of a drive having the head 36 (hereinafter, referred to as the drive EWAC value).

The above parameters are related to the recording performance of the HDD 1. The MRR value of the head 36 denotes the intensity of a magnetic field formed by the head 36. The EWAC value of the head 36 denotes a write width including an erasure region by an AC field.

A manufacturing process of the HDD 1 will be briefly described before describing the relationship between the parameters discussed above and the FH of a head 36.

First, in a first operation of the manufacturing process of the HDD 1, a HSA 30 (see FIG. 1) assembly process is performed. In a second operation, a servo write process of writing a servo pattern to servo control of the head 36 to the disks 11 is performed. In a third operation, a function test process of determining whether the HSA 30 assembled in the HSA assembling process is normally operated is performed. In a fourth operation, a burn-in process is performed. The burn-in process assists in detecting the reliability of particular components prior to the final assembly of the HDD 1. In a final operation, a final test process is performed, which tests the operation and reliability of a completely manufactured HDD 1. The above-described operations are mere examples and other processes may be added between the operations or before and after a particular operation.

The MRR value of a head can be measured at each operation of the manufacturing process of the HDD 1 so as to be easily measured and applied to, whereas a direct relationship with the FH is low. In other words, although the MRR value of the head 36 may be loosely related to the FH so as not to be able to provide an intuitive value with respect to the FH, it has a merit of being measured in each operation. At least one relevant parameter determined from the MRR value is a band, which is a band or width between the maximum FH and the minimum FH, or a tendency thereof that may be applied to optimize of the FH.

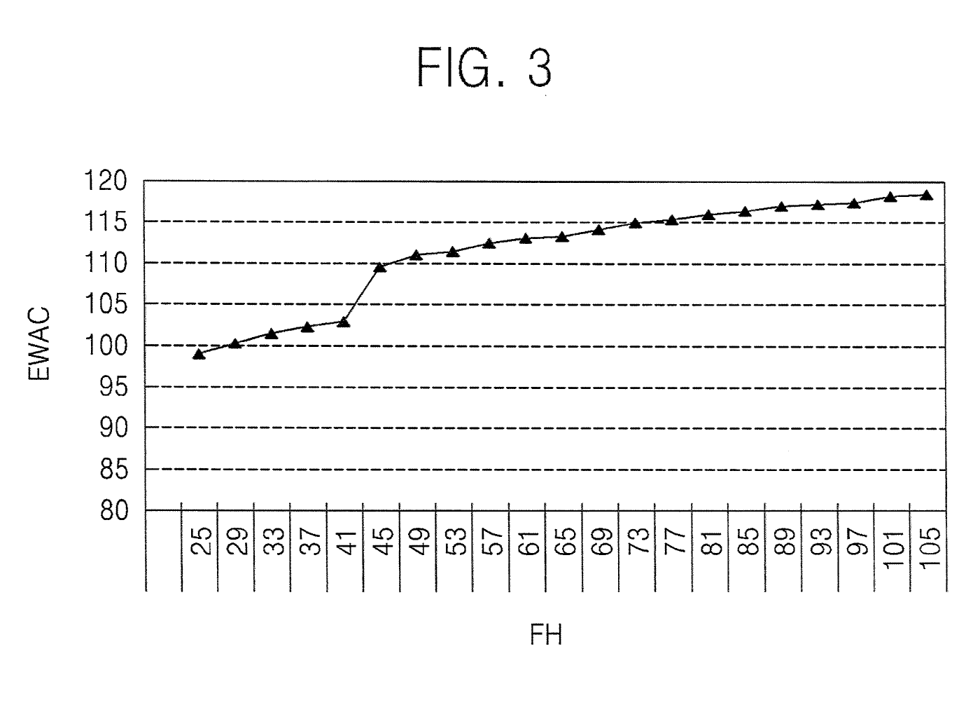

FIG. 3 is a graph illustrating a relationship between the EWAC value and the FH of a head. More specifically, the EWAC value of a head has a direct relationship with the FH because the relationship with the FH of the head 36 can be seen by measuring the EWAC value. As illustrated in FIG. 3, the EWAC increases as the value the FH increases. The EWAC value of a head may be measured during a burn-in process of the HDD 1.

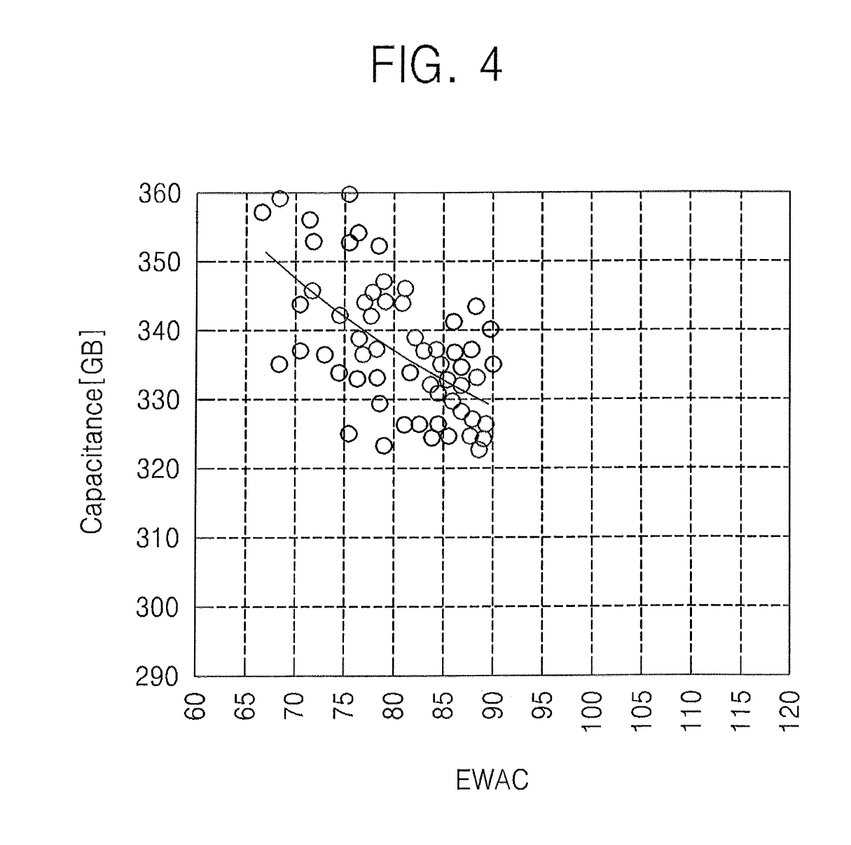

FIG. 4 is a graph showing a relationship between an EWAC value and recording capacitance of recording performance of an HDD. Referring to FIG. 4, a least squares curve fitted to the data points indicated in the graph illustrates that as the EWAC value of a head increases, a recording capacitance value decreases. Accordingly, the recording capacitance value may be directly determined using the EWAC value of a head measured in the HDD manufacturing process.

To further optimize the recording performance of a hard disk drive apparatus, the part properties of the head 36 itself and the part properties of the head 36 in a state of being installed at the HDD 1 may be taken into account. More specifically, the characteristics of the head 36, such as the properties of the parts and the physical properties of the head 36, may change according the level at which the HDD 1 is driven during the assembly and test processes. Thus, there is a need to consider characteristics of a parameter value of the head 36 itself and a parameter value in a level of a hard disk drive to which the head 36 is assembled. The MRR value of a head is typically provided by part manufacturers and the MRR value of the hard disk drive is typically measured using various measuring equipments from the HDD 1 that is assembled.

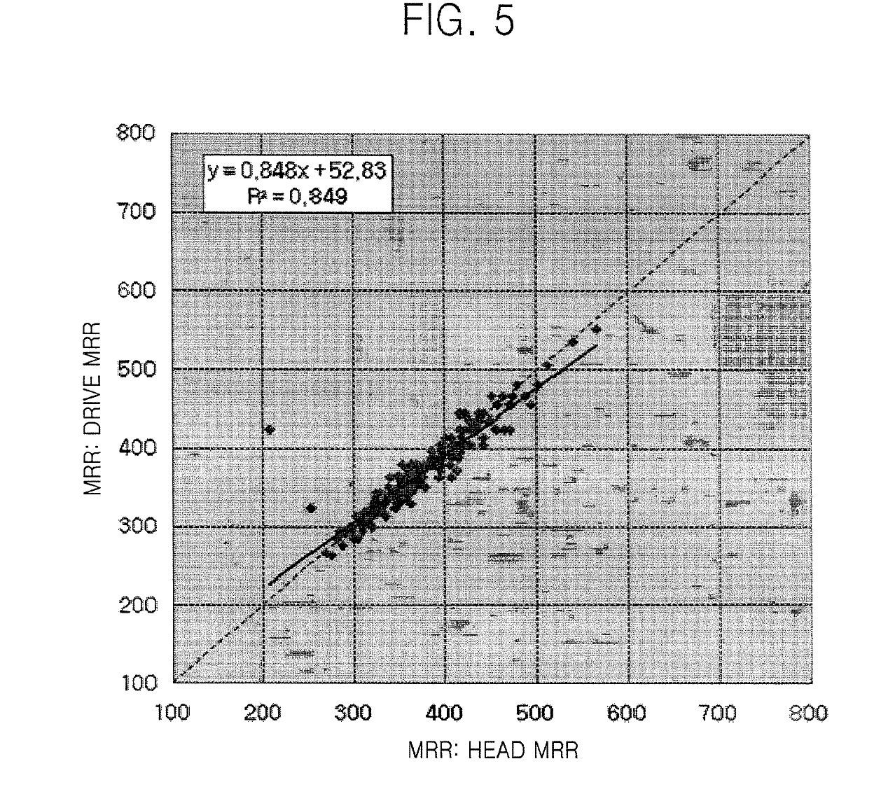

FIG. 5 is a graph showing a relationship between the MRR value of a head and the MRR value of an HDD. Referring to FIG. 5, the MRR value of a head and the MRR value in a level of a hard disk drive are proportional to each other. That is, the graph of FIG. 5 illustrates a degree of linear relationship between the MRR value of the head 36 and the MRR value of the HDD 1. Further, the graph indicates a squared correlation coefficient (r²) equal to 0.849, such that the correlation coefficient of graph approximately 0.922.

Thus, the measuring of a parameter value of a hard disk drive (drive MRR value) may be the same as that of a parameter value of the head 36 (head MRR value). In other words, the relationship of the head MRR value and the EWAC value with respect to the FH may be recognized through the drive MRR value or the drive EWAC value measured in a level of a hard disk drive during the manufacturing process of the HDD 1.

As a result, any one of parameter values including the head MRR value, a head EWAC value, the drive MRR value, and the drive EWAC value may be used to optimize a flying height FH of the head 36. In the at least one exemplary embodiment, a head MRR value is used to determine an optimal flying height FH of the head 36.

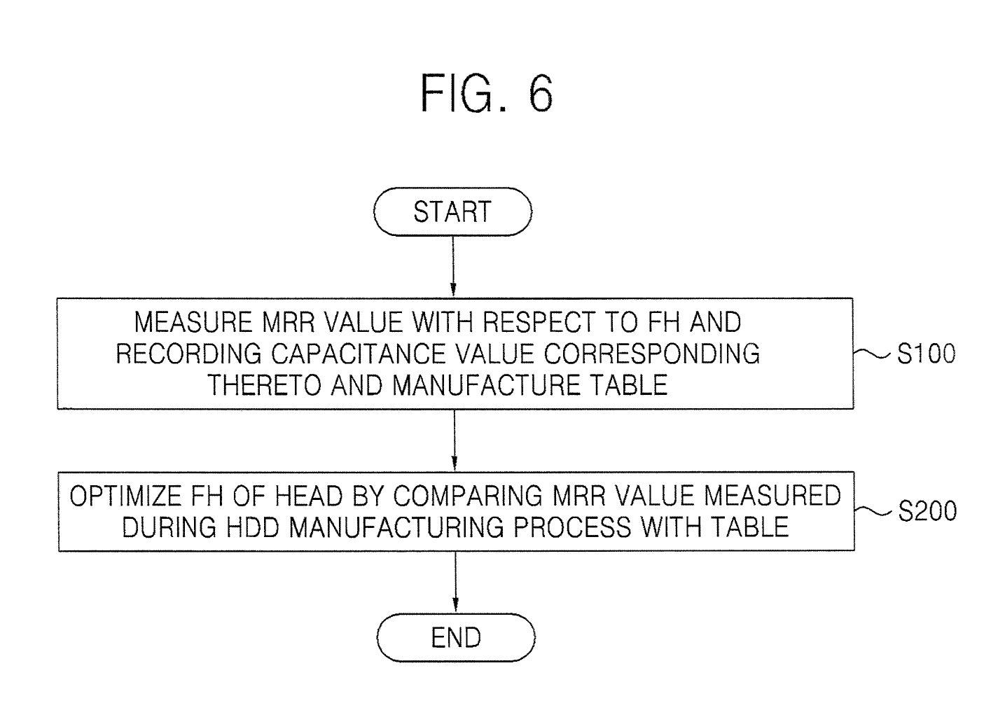

The controller 42 (see FIG. 2) provided in the HDD 1 of the at least one exemplary embodiment controls the method of optimizing an FH of a head 36. The process of performing the method of optimizing an FH of a head 36 will be described in detail with reference to FIGS. 6-9.

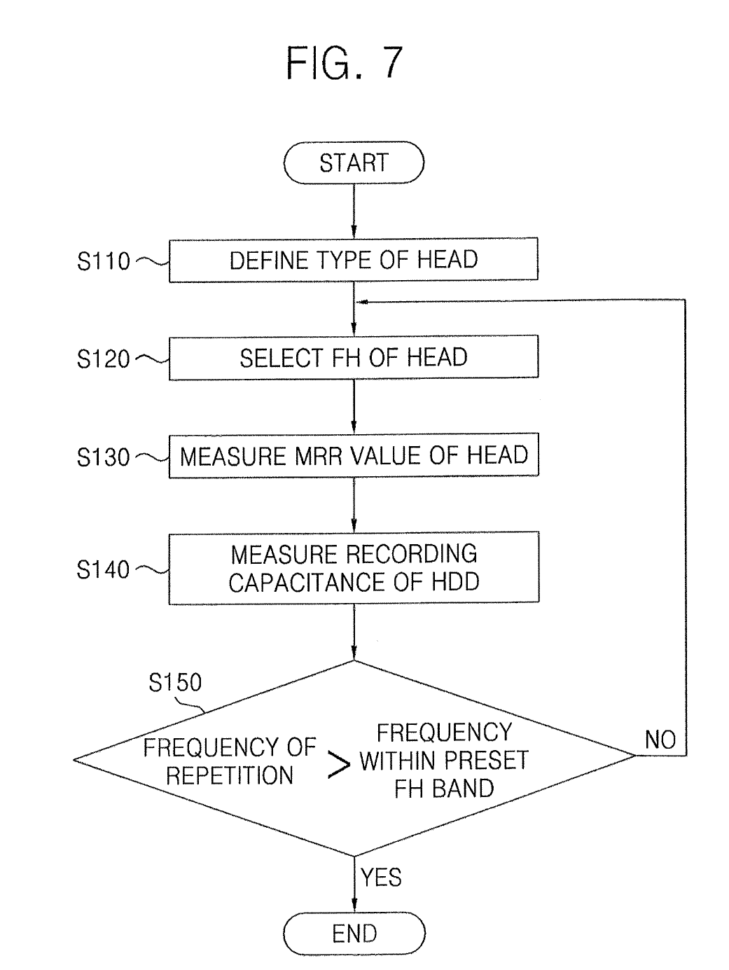

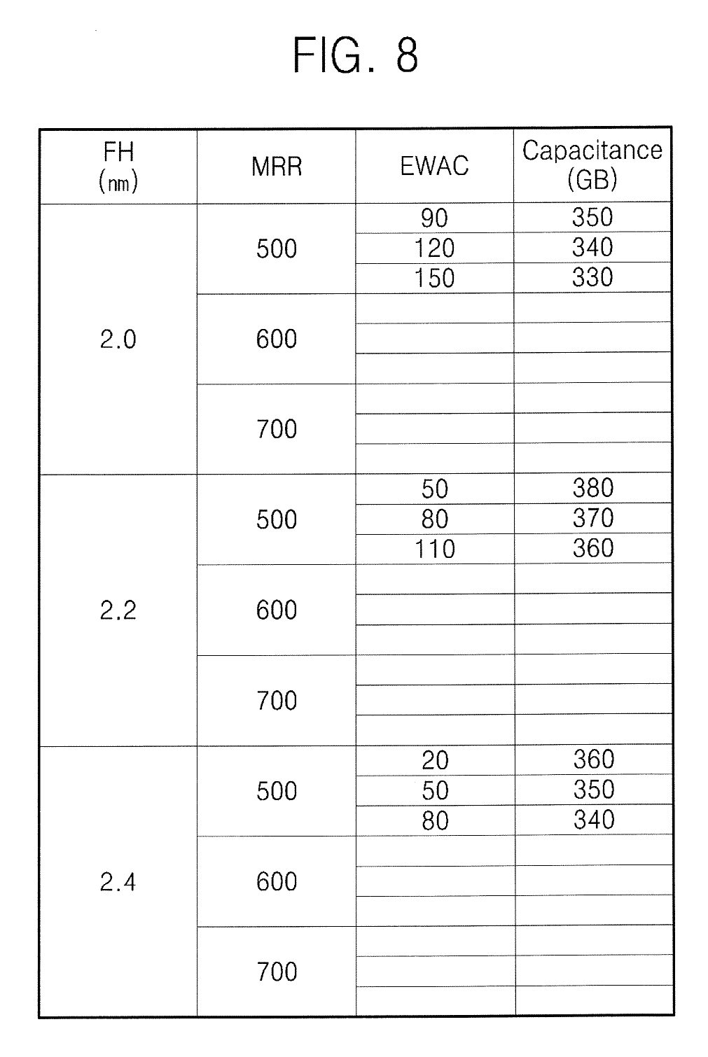

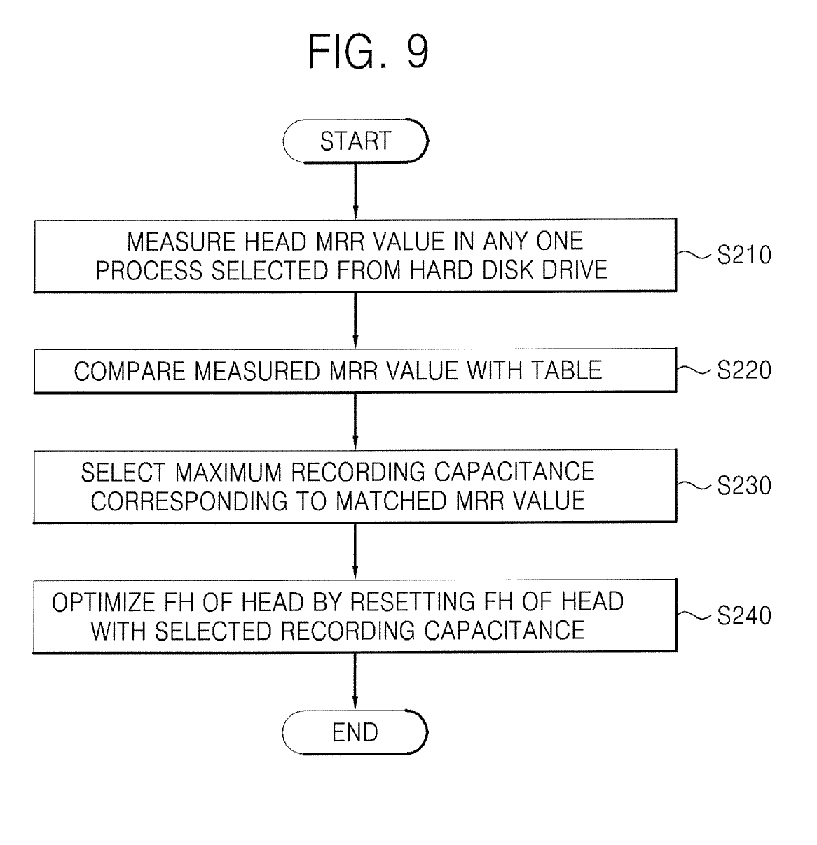

FIG. 6 is a flowchart illustrating an exemplary method of optimizing an FH of a head 36 according to an exemplary embodiment of the present general inventive concept. FIG. 7 is a flowchart illustrating a table generating operation. FIG. 8 shows an exemplary table including table values preset according to the exemplary method of FIG. 7. The generated table may include various parameters including, but not limited to flying height (FH), magnetic resistor resistance (MRR), write width including an erase band width by an AC field (EWAC) and recording capacitance. Accordingly, a measured parameter, which is measured during a manufacturing process of the HDD 1, may be cross-referenced with a parameters included in the generated table such that a FH of the head 36 may optimized. FIG. 9 is a flowchart illustrating an exemplary method of optimizing an FH of a head during an HDD manufacturing process.

Referring to FIGS. 6-9, the method of optimizing recording capacitance of the HDD 1 includes measuring a parameter value corresponding to the FH of a head, and measuring a recording capacitance value of the HDD 1 corresponding to the parameter value. Based on the measured values, a predetermined table is generated (S100). Accordingly, the FH of a head may be optimized by comparing the parameter values measured in the manufacturing process of the HDD 1 with the table (S200), as discussed in greater detail below.

First, the operation S100 to generate the table will be described with reference to FIG. 7. Although the table generating operation S100 may be performed simultaneously with the start of the process, a complete table may be generated before the HDD manufacturing process starts.

In the table generating operation, which is described in detail with reference to FIG. 7, the type of the head 36 is defined (S110). Next, a preset FH of the head 36, that is the minimum value of preset FH band values when it is the first case, is selected (S120).

Next, the MRR value of a head is measured in each operation of the HDD manufacturing process according to the FH of a head, and a measured MRR value of a head is stored (S130). Next, recording capacitance is measured based on the measured MRR value of a head. The measured values are recorded and stored on at least one of the disks 11 and/or the buffer memory 46 (S140).

Then, the FH of a head is increased by a preset small variation amount, and the operation S120 is repeated. That is, the MRR value of a head with respect to the FH of a head that is an accumulation of small increases is measured and recording capacitance at this time is measured (S150).

Consequently, a table is completed by repeatedly measuring and recording the MRR value of a head (dependent variable) and a recording capacitance value (dependent variable) by changing the FH (independent variable). The frequency of repetitions of the measuring and recording operations is previously set by an operator. Contrary to the above, a condition that the measuring and recording operations are repeated until a sum of the small variation amounts exceeds the maximum value of a preset FH band may be given to the FH accumulated at the n-th number repeated operation. The band (bandwidth) of FH, the minimum FH value, the maximum FH value, and the small variation amount may be preset in the repeated operations.

The completed table may be recorded and stored in a maintenance region MC (not shown) of the disks 11 and/or in the buffer memory 46. If necessary, a storage means including, but not limited to, a ROM and/or an external memory may be used.

When the HDD manufacturing process is changed, such as changing the type of the head 36, each part of the HDD 1, or a production line, the table value with respect to the head 36 needs to be measured again and then recorded and stored.

In the meantime, as described above, the operation S200 (see FIG. 6) of optimizing the FH of a head using a pre-generated table is performed after the table generation operation (S100) is completed.

As described above, the head MRR value and the drive MRR value may be measured in each HDD manufacturing process. In contrast, the head EWAC value and the drive EWAC value may be measured in the burn-in process of the HDD manufacturing process.

The FH of a head when the head 36 is first assembled is set to a preset default value. The default value may be provided during the HDD manufacturing process.

Referring now to FIG. 9, an exemplary method of optimizing a FH of the head 36 is illustrated. The operation of optimizing the FH of a head (S200) includes an operation of measuring a parameter value during any one selected manufacturing process from the operations of the manufacturing process of the HDD 1 (S210). For example, a MRR of the head 36 corresponding to a selected manufacturing process of the HDD 1, such as a burn-in process, may be measured. A comparison is executed, which compares the measured parameter value, with the values of the generated table (S220). The measured MRR value, for example, may be matched to a pre-generated MRR value included in the table. Based on the comparison, an optimal recording capacitance among the values of the table corresponding to the parameter value is selected (S230). For example, a maximum recording capacitance listed in the pre-generated table may be selected based on a match between the measured MRR value and the MRR value of the pre-generated table. Accordingly, the FH of a head may be optimized by resetting the FH of a head based on the selected optimal recording capacitance value (S240).

The operation of optimizing the FH of the head 36 based on the comparison between the MRR value measured during HDD manufacturing process with the parameter value included in the generated table (S200) may be performed by the CPU 41 (see FIG. 2), which is connected to the controller 42 (see FIG. 2). The comparison of an MRR value and the selection of an optimal recording capacitance may be displayed on a display device connected to an operation device, or a computer so that an operator may recognize the optimization process.

As such, since the FH of a head having the maximum recording capacitance value may be reset according to the type and properties of the head 36, optimization in relation with the recording performance of the HDD 1 may be achieved.

Also, since the FH of a head is optimized by comparing and analyzing the head MRR value and the table values corresponding thereto using a pre-generated table, loss of recording capacitance of the HDD 1 throughout the overall HDD manufacturing process may be prevented.

Although in the above description the head MRR value is mainly described as a parameter value, as described above, other parameter values may be used to perform optimization of the FH, such as the drive MRR value, the EWAC value having a direct relationship with the FH, and/or the drive EWAC value.

An exemplary method of optimizing an FH of a head of the HDD 1 configured as above will be described with reference to a table of FIG. 8. It can be appreciated that the units and figures are freely selected.

A table is generated as illustrated in FIG. 8 before the manufacturing process of the HDD 1 is performed. Since the table generating process is the same as that described above, a description on the process will be omitted herein.

The manufacturing process of the HDD 1 starts when the FH is set to a default value. For example, the FH may be set to 2 nm. The head MRR value is measured in at least one of the above-described manufacturing processes including, but not limited to, a head stack assembly assembling process, a servo write process, a function test process, a burn-in process, and a final test process. When the measured head MRR value reaches a pre-determined MRR value, for example, 500, the measured MRR value is recorded and stored.

The measured MRR value is compared with the MRR value of the table by the controller or the CPU. Another FH of the head 36 and a recording capacitance value when the head MRR value is 500 are compared with each other. As illustrated in FIG. 8, when the FH is 2 nm, 2.2 nm, and 2.4 nm, the maximum recording capacitance among the plurality of recording capacitance values included in the generated table is 350 GB, 380 GB, and 360 GB, respectively.

The maximum recording capacitance value may be selected among the comparison values. For example, a desired recording capacitance value of 380 GB may be selected. Accordingly, the FH to which the selected recording capacitance value belongs is selected. That is, since the recording capacitance value of 380 is selected, the optimal FH of the head 36 is determined to be 2.2 nm based on the generated table.

The selected FH is reflected in the HDD manufacturing process and then the FH of a head is readjusted and the HDD manufacturing process is performed or completed. The optimization of an FH of a head may be achieved according to the same method described above using a head EWAC value as a selected parameter value, instead of the head MRR value.

As such, according to the recording optimization method of the present general inventive concept, the recording capacitance of the HDD 1 may be optimized by varying the FH of a head.

Alternatively, the FH of a head may be selected without performing the table generating process discussed above.

More specifically, a method of optimizing the FH of the head 36 may be achieved by repeatedly measuring parameter values, for example, an MRR value and an EWAC value during a manufacturing process of the HDD 1, such as a burn-in process, freely setting the FH of the head 36 according to each measured value, and measuring recording capacitance of the HDD 1 at the set FH of the head 36, without the table manufacturing process.

The present general inventive concept may be embodied by a method, an apparatus, or a system. The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, an FH of a head is optimized based on a preset table value and a magnetic resistor resistance (MRR) value of a head measured during the HDD manufacturing process so that recording capacitance may be improved.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A method of optimizing a flying height of a head of a hard disk drive, the method comprising:
measuring at least one parameter value with respect to the flying height of the head and a recording capacitance value of the hard disk drive corresponding to the parameter value and generating a predetermined table including measured values based on the at least one measured parameter value; and
optimizing the flying height of the head by comparing a measured process parameter value corresponding to at least one hard disk drive manufacturing process with at least one measured value of the table.

2. The method of claim 1, wherein the optimizing of the flying height of the head comprises:
measuring the process parameter value in the at least one hard disk drive manufacturing process; and
comparing the measured process parameter value of the at least one manufacturing process with a corresponding measured value of the table.

3. The method of claim 2, wherein the optimizing of the flying height of the head further comprises:
selecting an optimal recording capacitance value among the measured values of the table corresponding to the parameter value; and
optimizing the flying height of the head by resetting the flying height of the head based on the optimal recording capacitance value.

4. The method of claim 3, wherein the optimal recording capacitance value is a maximum value among the recording capacitance values of the table.

5. The method of claim 1, wherein the parameter value is selected from an MRR (magnetic resistor resistance) value of the head, an EWAC (write width including an erase band width by an AC field) value of the head, an MRR value of the hard disk drive, and an EWAC value of the hard disk drive, and the hard disk manufacturing process comprises a head stack assembly assembling process, a servo write process, a function test process, a burn-in process, and a final test process.

6. The method of claim 5, wherein the MRR value of the head is measured in at least any one process selected from the entire processes of the hard disk drive manufacturing process.

7. The method of claim 5, wherein the EWAC value of the head is measured during the burn-in process.

8. The method of claim 1, wherein the measuring of each of a parameter value with respect to the flying height of the head, and a recording capacitance value of the hard disk drive corresponding to the parameter value and the generating of a predetermined table based on measured values, comprises:
defining a type of the head;
selecting a flying height of the head;
measuring at least one parameter value based on the flying height of the head; and
measuring recording capacitance of the hard disk drive according to a measured parameter value.

9. The method of claim 1, wherein the table generated in the measuring of a parameter value with respect to the flying height of the head and a recording capacitance value of the hard disk drive corresponding to the parameter value and the generating of a predetermined table based on measured values is stored in a memory or on a disk.

10. A hard disk drive comprising:
a head to read/write information with respect to a disk; and
a controller in electrical communication with a memory unit to optimize a flying height of a head by comparing parameter values measured corresponding to a hard disk drive manufacturing process with a pre-generated table stored in the memory unit,
wherein the table is generated based on measured values of a parameter value with respect to the flying height of the head and a recording capacitance value of the hard disk drive corresponding to the parameter value.

11. The hard disk drive of claim 10, wherein the controller measures the parameter value in any one process selected from the hard disk drive manufacturing process, compares a measured parameter value with values on the table, selects an optimal recording capacitance value of the corresponding values on the table corresponding to the parameter value, and controls optimization of the flying height of the head by resetting the flying height of the head based on the optimal recording capacitance value.

12. The hard disk drive of claim 11, wherein the optimal capacitance value is a maximum value of the recording capacitance values on the table.

13. The hard disk drive of claim 10, wherein the parameter value is selected from an MRR (magnetic resistor resistance) value of the head, an EWAC (write width including an erase band width by an AC field) value of the head, an MRR value of the hard disk drive, and an EWAC value of the hard disk drive, and the hard disk manufacturing process comprises a head stack assembly assembling process, a servo write process, a function test process, a burn-in process, and a final test process.

14. The hard disk drive of claim 13, wherein the MRR value of the head is measured in at least any one process selected from the entire processes of the hard disk drive manufacturing process, and the EWAC value of the head is measured in the burn-in process.

15. A hard disk drive module including at least one disk to store data, the hard disk drive module comprising:
a head disposed above the at least one disk and adjustable according to a flying height;
memory unit to store a plurality of parameters measured during a pre-determined manufacturing process of the hard disk drive module; and
a controller in electrical communication with the memory unit to output a plurality of control signals in response to each measured parameter among the plurality of measured parameters such that each control signal sets the head at a corresponding flying height,
wherein a recording capacitance of the hard disk drive module is measured at each flying height set by the corresponding control signal generated by the controller.

16. The hard disk drive module of claim 15, wherein the pre-determined manufacturing process is a burn-in process.

17. A method of optimizing a flying height of a head included in a hard disk drive module including at least one disk to store data, the method comprising:
storing a plurality of parameters measured during a pre-determined manufacturing process of the hard disk drive module;
setting the head at a plurality of flying heights, each flying height corresponding to a measured parameter among the plurality of measured parameters; and
measuring a recording capacitance of the hard disk drive module at each set flying height.

18. The method of claim 17, wherein the pre-determined manufacturing process is a burn-in process.

19. The method of claim 17, wherein the plurality of parameters includes a magnetic resistor resistance (MRR) value of the head and a write width including an erase band width by an AC field (EWAC) of the head.

20. A method of optimizing a flying height of a head of a hard disk drive, the method comprising:
determining a manufacturing process of the hard disk drive during which to optimize the flying height of the head;
measuring during the determined manufacturing process a parameter of the head to be cross-referenced with a pre-determined parameter listed in a pre-generated table stored in a memory unit;
matching the measured parameter with the pre-determined parameter to determine a corresponding recording capacitance of the head; and
adjusting the flying height of the head according to the determined recording capacitance.
